(19) United States
(12) Patent Application Publication
(10) Pub. No.: US 2015/0079421 A1
(43) Pub. Date: Mar. 19, 2015

(54) ELECTRICAL COMPONENT AND METHOD FOR FABRICATING SAME

(71) Applicants: TYCO ELECTRONICS AMP GMBH, BENSHEIM (DE); TYCO ELECTRONICS CORPORATION, BERWYN, PA (US)

(72) Inventors: Marjorie Myers, Mount Wolf, PA (US); Helge Schmidt, Speyer (DE)

(73) Assignees: TYCO ELECTRONICS AMP GMBH, BENSHEIM (DE); TYCO ELECTRONICS CORPORATION, BERWYN, PA (US)

(21) Appl. No.: 14/031,917

(22) Filed: Sep. 19, 2013

(51) Int. Cl. H01B 1/02; H01B 13/00

(52) U.S. Cl. CPC H01B 1/02; H01B 13/0036
USPC 428/670; 427/125

(57) ABSTRACT

An electrical component includes an interior layer that includes an exterior surface. The electrical component includes an intermediate layer that includes at least one platinum group metal (PGM). The intermediate layer extends on the exterior surface of the interior layer. The intermediate layer has an exterior PGM surface. The electrical component includes a silver layer that includes silver. The silver layer extends on the exterior PGM surface such that the intermediate layer extends between the interior layer and the silver layer.

### BACKGROUND OF THE INVENTION

The subject matter described and/or illustrated herein relates generally to electrical components, and more particularly to electrical components having nickel and silver layers.

Electrical components are used to provide electrical pathways between various components for a variety of applications. Electrical contacts, electrical traces, electrical vias, electrical wires, and the like are examples of electrical components that provide electrical pathways. At least some known electrical components include an interior layer of nickel and a layer of silver that extends over the nickel layer. But, silver and nickel have little or no mutual solubility or reaction with each other, such that the nickel and silver layers do not readily interdiffuse and form a relatively strong bond. Moreover, oxygen readily diffuses through silver. If enough oxygen gets to the interface between the nickel and silver layers, the resulting oxide layer that forms at the nickel/silver interface may weaken the bond between the nickel and silver layers, which may cause the silver layer to delaminate from the nickel layer. Delamination of the silver layer is not limited to electrical components having interior layers of nickel (i.e., is not limited to silver and nickel interfaces). Rather, oxidation may cause a silver layer to delaminate from interior layers fabricated from other materials (e.g., an interface between a silver layer and an interior layer of copper and/or another material).

It is known to use a minimal strike layer (e.g., acid silver strike) between the nickel and silver layers to enhance the adhesion between the nickel and silver layers. Such a strike layer can facilitate preventing the silver layer from delaminating at temperatures below approximately 150° C. But, at least some known electrical components are used in applications where the electrical component is exposed to temperatures greater than approximately 150° C. For example, electrical components may be used in automotive and/or aerospace applications wherein the environment (e.g., an engine compartment) of the electrical component is exposed to temperatures greater than approximately 150° C. But, the silver layer may delaminate from the nickel layer when the electrical component is exposed to temperatures greater than approximately 150° C. For example, at temperatures greater than approximately 150° C., the adhesion between the nickel and silver layers may be degraded enough to lead to delamination caused by the formation of a nickel oxide layer at the interface between the silver and nickel layers. Accordingly, the silver layers of at least some known electrical components may delaminate when the electrical component is exposed to temperatures greater than approximately 150° C.

### BRIEF DESCRIPTION OF THE INVENTION

In an embodiment, an electrical component includes an interior layer that an exterior surface. The electrical component includes an intermediate layer that includes at least one platinum group metal (PGM). The intermediate layer extends on the exterior surface of the interior layer. The intermediate layer has an exterior PGM surface. The electrical component includes a silver layer that includes silver. The silver layer extends on the exterior PGM surface such that the intermediate layer extends between the interior layer and the silver layer.

In an embodiment, a method is provided for fabricating an electrical component. The method includes depositing an intermediate layer on an exterior surface of an interior layer of the electrical component. The intermediate layer includes at least one platinum group metal (PGM) and has an exterior PGM surface. The method includes depositing a silver layer on the exterior PGM surface of the intermediate layer such that the intermediate layer extends between the interior layer and the silver layer. The silver layer is fabricated at least partially from silver.

In an embodiment, an electrical component includes an interior layer that includes an exterior surface. An intermediate layer extends on the exterior surface of the interior layer. The intermediate layer has an exterior PGM surface. The electrical component includes a silver layer that includes silver. The silver layer extends on the exterior PGM surface such that the intermediate layer extends between the interior layer and the silver layer. The intermediate layer is fabricated from at least one material that does not oxidize such that the intermediate layer provides a barrier that prevents an oxide layer from forming on the exterior surface of the interior layer.

### BRIEF DESCRIPTION OF THE DRAWINGS

FIG. 1 is a perspective view of an embodiment of an electrical contact.

FIG. 2 is a cross-sectional view of the electrical contact shown in FIG. 1 taken along line 2-2 of FIG. 1.

FIG. 3 is a cross-sectional view of another embodiment of an electrical contact.

FIG. 4 is a flowchart illustrating an embodiment of a method for fabricating an electrical contact.

### DETAILED DESCRIPTION OF THE INVENTION

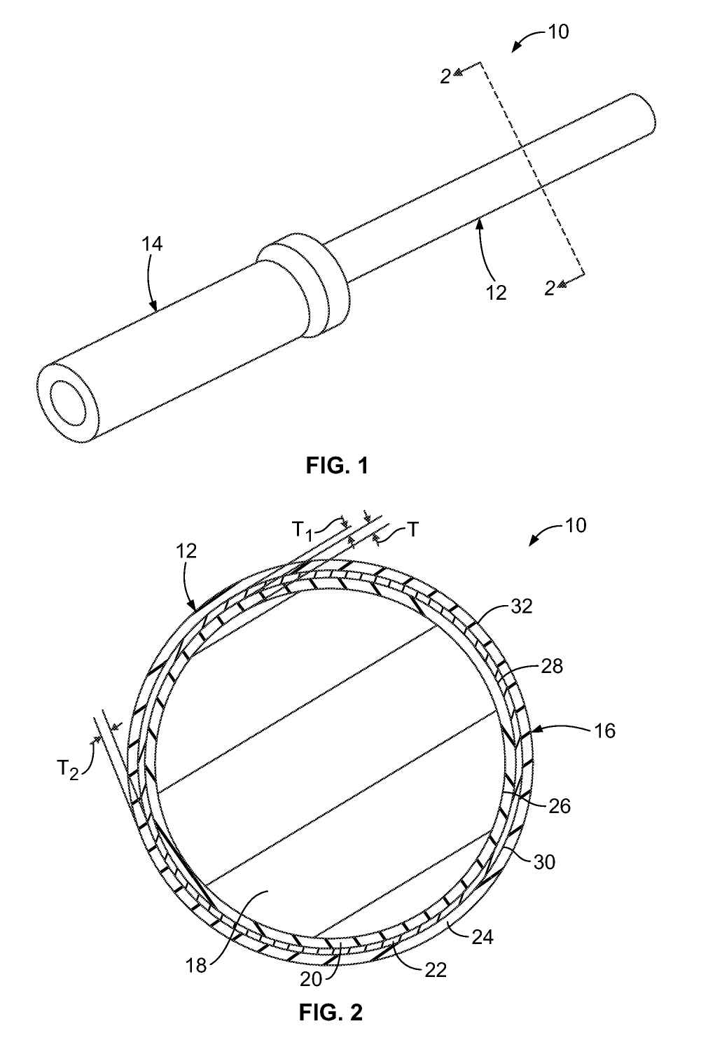

FIG. 1 is a perspective view of an embodiment of an electrical component 10. In the illustrated embodiment, the electrical component 10 is an electrical contact (i.e., an electrical terminal) that is configured to mate with a complementary electrical contact (not shown). But, the electrical component 10 is not limited to being an electrical contact. Rather, the electrical component 10 may be any other type of electrical component that provides an electrical pathway, such as, but not limited to, an electrical trace, an electrical via, an electrical wire, an electrical contact pad (i.e., a surface mount electrical contact), and/or the like. The electrical component 10 will be referred to throughout the remainder of the DETAILED DESCRIPTION OF THE INVENTION as an “electrical contact” 10.

The electrical contact 10 extends from a mating segment 12 to a mounting segment 14. The electrical contact 10 is configured to be mated with the complementary electrical contact at the mating segment 12. The mounting segment 14 of the electrical contact 10 is configured to be mounted to a substrate (not shown; e.g., a circuit board and/or the like), terminated to an electrical wire (not shown; whether or not the electrical wire is grouped in a cable with one or more other electrical wires), and/or mounted to another structure.

In the illustrated embodiment of FIG. 1, the mating segment 12 is a pin that is configured to be received within a socket of the complementary electrical contact. But, the electrical contact 10 is not limited to the specific embodiment of the mating segment 12 described and/or illustrated herein. Rather, the pin of the mating segment 12 is meant as exemplary only. For example, in other embodiments, the mating segment 12 may be socket that is configured to receive a pin of the complementary electrical contact 10 therein. In still other embodiments, and for example, the mating interface 12 of the electrical contact 10 may include another structure, such as, but not limited to, a blade structure, a spring finger structure, another spring structure, and/or the like.

The mounting segment 14 of the electrical contact 10 is a crimp barrel in the illustrated embodiment of FIG. 1. The crimp barrel of the mounting segment 14 is configured to be crimped around the end of an electrical wire (not shown). But, the electrical contact 10 is not limited to the specific embodiment of the mounting segment 14 that is described and/or illustrated herein. Rather, the crimp barrel of the mounting segment 14 is meant as exemplary only. For example, in other embodiments, the mounting segment 14 may have a different crimp structure than the crimp barrel. Moreover, and for example, the mounting segment 14 may include a solder tail, a surface mount structure, a spring structure, a press-fit pin (e.g., an eye-of-the needle pin and/or the like), a solder interface, a weld interface, and/or the like.

Although shown as extending along an approximately straight path between the mating segment 12 and the mounting segment 14, the electrical contact 10 may have another shape. For example, the electrical contact 10 may include one or more bends (not shown) such that the path of the electrical contact 10 between the mating and mounting segments 12 and 14, respectively, is not approximately straight. One specific example of another shape of the electrical contact 10 is an electrical contact that has an approximately 90° bend between the mating segment 12 and the mounting segment 14 such that the electrical contact 10 is a right-angle contact.

The electrical contact 10 may be configured to conduct electrical data signals, electrical power, or electrical ground. Moreover, the electrical contact 10 may be used in any application, within any type of electrical connector (not shown), and/or the like. Examples of suitable applications of the electrical contact 10 are automotive applications, aerospace applications, electrical power generation and/or distribution applications, communication applications, and/or the like. In some embodiments, the electrical contact 10 is used in an application where the electrical contact 10 is exposed to temperatures greater than approximately 150° C. For example, the electrical contact 10 may be used in automotive and/or aerospace applications wherein the environment (e.g., an engine compartment and/or the like) of the electrical contact 10 is exposed to temperatures greater than approximately 150° C.

FIG. 2 is a cross-sectional view of the electrical contact 10 taken along line 2-2 of FIG. 1. At least a portion of the electrical contact 10 includes a layered structure 16 having a base 18, an interior layer 20, an intermediate layer 22, and a silver (Ag) layer 24. As will be described below, the intermediate layer 22 extends between the interior layer 20 and the silver layer 24 and is fabricated from at least one material that does not oxidize such that the intermediate layer 22 prevents a reaction layer (e.g., an oxide layer) from forming on the interior layer 20.

As should be apparent from line 2-2 of FIG. 1, in the illustrated embodiment of FIGS. 1 and 2, the layered structure 16 of the electrical contact 10 defines at least a portion of the mating segment 12 of the electrical contact 10. The layered structure 16 may define any amount of the mating segment 12 and may define any location(s) along the mating segment 12. In the illustrated embodiment of FIGS. 1 and 2, the layered structure 16 defines an approximate entirety of the mating segment 12.

In some embodiments, and in addition or alternative to at least a portion of the mating segment 12 being defined by the layered structure 16, one or more other portions (e.g., the mounting segment 14) of the electrical contact 10 is at least partially defined by the layered structure 16. Any amount of, and any location(s) along, such other portion(s) of the electrical contact 10 may be defined by the layered structure 16.

Although shown as having a circular cross-sectional shape herein, the layered structure 16 may include any other cross-sectional shape, such as, but not limited to, a rectangular cross-sectional shape, a square cross-sectional shape, another four-sided cross-sectional shape, an oval cross-sectional shape, a triangular cross-sectional shape, a cross-sectional shape having greater than four sides, and/or the like.

Referring now to structure of the layered structure 16 as shown in FIG. 2, the base 18 includes an exterior base surface 26 that defines a cross-sectional perimeter of the base 18. As will be described below, in the illustrated embodiment of FIGS. 1 and 2, the interior layer 20 extends on the exterior base surface 26 of the base 18. The base 18 may have any cross-sectional size (e.g., any diameter in the illustrated embodiment of FIGS. 1 and 2).

The base 18 may be fabricated from any materials. In some embodiments, the base 18 includes copper (Cu). For example, the base 18 may be fabricated approximately entirely from copper, or may be only partially fabricated from copper. Examples of embodiments wherein the base 18 is fabricated only partially from copper include, but are not limited to, fabricating the base 18 from a copper alloy, fabricating the base 18 from copper clad steel, fabricating a majority (but less than an approximate entirety) of the base 18 from copper, fabricating equal to or less than approximately 90% of the base 18 from copper, fabricating equal to or less than approximately 95% of the base 18 from copper, and fabricating between approximately 95% and approximately 99% of the base 18 from copper. Examples of copper alloys from which the base 18 may be fabricated include, but are not limited to, brass, phosphor bronze, aluminum (Al) bronze, silicon (Si) bronze, copper nickel (Ni), and/or the like. Examples of other materials that the base 18 may be fabricated from in addition or alternative to copper include, but are not, limited to, tin (Sn), zinc (Zn), aluminum, iron (Fe), silicon, nickel, gold (Au), silver, and/or the like.

As shown in FIG. 2, the interior layer 20 extends on the exterior base surface 26 of the base 18. The interior layer 20 includes an exterior surface 28 that defines a cross-sectional perimeter of the interior layer 20. As will be described below, the intermediate layer 22 extends on the exterior surface 28 of the interior layer 20. The interior layer 20 may have any cross-sectional thickness T.

The interior layer 20 may be fabricated from any materials that enable oxidation to form on the exterior surface 28. In some embodiments, the interior layer 20 includes copper (Cu). For example, the interior layer 20 may be fabricated approximately entirely from copper, or may be only partially fabricated from copper. Examples of embodiments wherein the interior layer 20 is fabricated only partially from copper include, but are not limited to, fabricating the interior layer 20 from a copper alloy, fabricating the interior layer 20 from copper clad steel, fabricating a majority (but less than an approximate entirety) of the interior layer 20 from copper, fabricating equal to or less than approximately 90% of the interior layer 20 from copper, fabricating equal to or less than approximately 95% of the interior layer 20 from copper, and fabricating between approximately 95% and approximately 99% of the interior layer 20 from copper. Examples of copper alloys from which the interior layer 20 may be fabricated include, but are not limited to, brass, phosphor bronze, aluminum (Al) bronze, silicon (Si) bronze, copper nickel (Ni), and/or the like. Examples of other materials that the interior layer 20 may be fabricated from in addition or alternative to copper include, but are not, limited to, tin (Sn), zinc (Zn), aluminum, iron (Fe), silicon, nickel, gold (Au), and/or the like.

In the illustrated embodiment, the interior layer 20 includes nickel. The interior layer 20 will be referred to sometimes below and sometimes otherwise herein as a “nickel layer” 20 and the exterior surface 28 will be referred to sometimes below as an “exterior nickel layer” 28. In the illustrated embodiment, at least a majority of the nickel layer 20 is fabricated from nickel. In some embodiments, an approximate entirety of the nickel layer 20 is fabricated from nickel. Examples of embodiments wherein a majority, but less than an approximate entirety, of the nickel layer 20 is fabricated from nickel include, but are not limited to, fabricating the nickel layer 20 from a nickel alloy, fabricating equal to or less than approximately 90% of the nickel layer 20 from nickel, fabricating equal to or less than approximately 95% of the nickel layer 20 from nickel, and fabricating between approximately 95% and approximately 99% of the nickel layer 20 from nickel. Examples of nickel alloys from which the nickel layer 20 may be fabricated include, but are not limited to, alnico, alumel, chromel, cupronickel, ferronickel, german silver, hastelloy, inconel, monel metal, nichrome, nickel-carbon, nicrosil, nisil, nitinol, mu-metal, permalloy, supermalloy, and/or the like.

In some embodiments, the base 18 and the interior layer 20 of the layered structure are the same layer (i.e., define a single layer of the layered structure). For example, as described above, the base 18 of the layered structure 16 may be fabricated from nickel (e.g., a majority or an approximate entirety of the base 18 may be fabricated from nickel) and/or copper (e.g., a majority or an approximate entirety of the base 18 may be fabricated from copper). In such embodiments wherein a majority or an approximate entirety of the base 18 is fabricated from the same material(s) as the interior layer 20, the base 18 defines the interior layer 20 such that the exterior base surface 26 is the same surface as the exterior surface 28. In other words, in some embodiments, the base 18 and the interior layer 20 do not define separate layers of the layered structure 16, but rather define a single continuous layer of the layered structure 16.

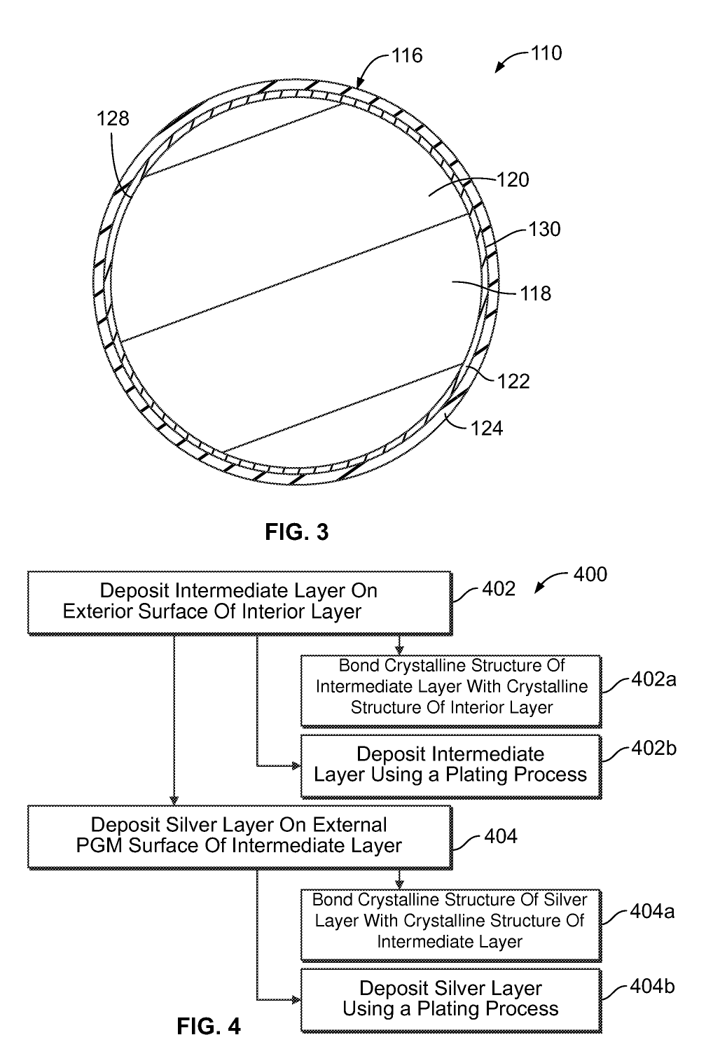

For example, FIG. 3 is a cross-sectional view of another embodiment of an electrical contact 110. At least a portion of the electrical contact 110 includes a layered structure 116 having a base 118, an intermediate layer 122, and a silver layer 124. The base 118 defines an interior layer 120 of the layered structure that includes an exterior surface 128. The intermediate layer 122 extends on the exterior surface 128 of the interior layer 20 and includes an exterior platinum group metal (PGM) surface 130 on which the silver layer 124 extends. The structure and function of the intermediate layer 122 is substantially similar to the intermediate layer 22 (FIG. 2) and therefore will not be described in more detail herein. The structure and function of the intermediate layer 22 will be described in more detail below.

Referring again to FIG. 2, the intermediate layer 22 extends on the exterior nickel surface 28 of the nickel layer 20. The intermediate layer 22 includes at least one PGM. The term “PGM” refers to six metallic elements clustered together in the periodic table. PGMs are transition metals lying in the d-block (groups 8, 9, and 10, periods 5 and 6) of the periodic table. The six platinum group metals are ruthenium (Ru), rhodium (Rh), palladium (Pd), osmium (Os), iridium (Ir), and platinum (Pt). PGMs may also be referred to as platinoids, platidises, platinum group, platinum metals, platinum family, or platinum group elements (PGEs).

The intermediate layer 22 includes an exterior PGM surface 30 that defines a cross-sectional perimeter of the intermediate layer 22. As will be described below, the silver layer 24 extends on the exterior PGM surface 30 of the intermediate layer 22. As shown in FIG. 2, the intermediate layer extends a cross-sectional thickness T₁ between the nickel layer 20 and the silver layer 24. The cross-sectional thickness T₁ of the intermediate layer 22 may have any value. Examples of the cross-sectional thickness T₁ of the intermediate layer 22 include, but are not limited to, less than approximately 500 nanometers (nm), between approximately 2 nm and approximately 501 nm, equal to or less than approximately 50 nm, and greater than or equal to approximately 1 nm. In some embodiments, the cross-sectional thickness T₁ of the intermediate layer 22 is greater than approximately 500 nm.

As described above, the intermediate layer 22 includes one or more PGMs. At least a majority of the intermediate layer 22 is fabricated from the one or more PGMs. For example, the intermediate layer 22 may be fabricated approximately entirely from the one or more PGMs. Examples of embodiments wherein a majority, but less than an approximate entirety, of the intermediate layer 22 is fabricated from the one or more PGMs include, but are not limited to, fabricating the intermediate layer 22 from a PGM alloy, fabricating equal to or less than approximately 90% of the intermediate layer 22 from the one or more PGMs, fabricating equal to or less than approximately 95% of the intermediate layer 22 from the one or more PGMs, and fabricating between approximately 95% and approximately 99% of the intermediate layer 22 from the one or more PGMs. In some embodiments, the intermediate layer 22 only includes a single PGM, whether or not the intermediate layer 22 also includes any non-PGM materials. Fabricating the intermediate layer 22 from a single PGM may be easier and/or less costly than fabricating the intermediate layer 22 from two or more PGMs. For example, it may be more difficult and/or costly to deposit (e.g., using a plating process and/or the like) the intermediate layer 22 on the exterior nickel surface 28 of the nickel layer 20 when the intermediate layer 22 includes two or more PGMs as compared to when the intermediate layer 22 includes only a single PGM. Moreover, and for example, it may be more costly to purchase, obtain, generate, and/or the like a substance that includes two or more PGMs as compared to a substance that includes only a single PGM. In one specific example embodiment, at least 95% of the intermediate layer 22 is fabricated from palladium and the intermediate layer does not include any other PGMs.

The silver layer 24 extends on the exterior PGM surface 30 of the intermediate layer 22. As shown in FIG. 2 and discussed above, the intermediate layer 22 extends between the nickel layer 20 and the silver layer 24. between the nickel layer 20 and the silver layer 24 within the layered structure 16 of the electrical contact 10. The silver layer 24 includes an exterior silver surface 32, which may define a cross-sectional perimeter of the mating segment 12 of the electrical contact 10 depending on whether any other layers extend on exterior silver surface 32 of the silver layer 24. The silver layer 24 may have any cross-sectional thickness T₂, which may be selected to provide the electrical contact 10 with a predetermined electrical conductivity.

The silver layer 24 includes silver. At least a majority of the silver layer 24 is fabricated from silver. In some embodiments, an approximate entirety of the silver layer 24 is fabricated from silver. Examples of embodiments wherein a majority, but less than an approximate entirety, of the silver layer 24 is fabricated from silver include, but are not limited to, fabricating the silver layer 24 from a silver alloy, fabricating equal to or less than approximately 90% of the silver layer 24 from silver, fabricating equal to or less than approximately 95% of the silver layer 24 from silver, and fabricating between approximately 95% and approximately 99% of the silver layer 24 from silver. Examples of silver alloys from which the silver layer 24 may be fabricated include, but are not limited to, argentium sterling silver, billon, Britannia silver, doré bullion, electrum, goloid, platinum sterling, shibuichi, sterling silver, Tibetan silver, and/or the like. The amount of silver contained within the silver layer 24 may be selected to provide the mating segment 12 of the electrical contact 10 a predetermined electrical conductivity.

The PGM(s) of the intermediate layer 22 is miscible in both nickel and silver such that the intermediate layer 22 has at least some mutual solubility with both nickel and silver (e.g., the PGM(s) of the intermediate layer 22 forms a continuous face-centered cubic (FCC) solid solution with both nickel and silver). Accordingly, the crystalline structure of the intermediate layer 22 is bonded with the crystalline structure of the nickel layer 20 at the interface between the layers 20 and 22, and the crystalline structure of the intermediate layer 22 is bonded with the crystalline structure of the silver layer 24 at the interface between the layers 22 and 24. The mutual bonding between the layers 20 and 22 and between the layers 22 and 24 provides a relatively strong and relatively stable adhesion between the layers 20 and 22, between the layers 22 and 24, and thereby between the nickel layer 20 and the silver layer 24, for example as compared to direct adhesion between silver and nickel. In some alternative embodiments, the PGM(s) of the intermediate layer 22 are compound forming (e.g., form intermetallics) with nickel such that the intermediate layer 22 forms a compound (e.g., forms intermetallics) with the nickel layer 20 at the interface between the nickel layer 20 and the intermediate layer 22.

The intermediate layer 22 provides a barrier that prevents delamination by preventing an oxide layer from forming between the nickel layer 20 and the silver layer 24. Specifically, the intermediate layer 22 does not oxidize because the PGM(s) of the intermediate layer 22 does not oxidize. Accordingly, even though oxygen readily diffuses through the silver layer 24, the intermediate layer 22 provides a barrier that prevents a deleterious oxide layer from forming at the interface between the nickel layer 20 and the intermediate layer 22 (e.g., on the exterior nickel surface 28). By preventing an oxide layer from forming on the exterior nickel surface 28, the barrier provided by the intermediate layer 22 prevents the silver layer 24 from delaminating from the nickel layer 20. For example, by preventing an oxide layer from forming at the interface between the layer 22 and the layer 20, the intermediate layer 22 prevents the bonds between the layer 22 and the layers 20 and 24 from being weakened. As used herein, “preventing” oxides and/or an oxide layer from forming is intended to mean preventing the formation of an oxide layer that is sufficient to cause delamination of the silver layer 24. In other words, “preventing” oxides and/or an oxide layer from forming, as used herein, does not necessarily mean that no oxidation is formed at the interface between the nickel layer 20 and the silver layer 24. Rather, “preventing” oxides and/or an oxide layer from forming, as used herein, may include the formation of localized discontinuous “lands” of oxide that are not sufficient (e.g., are not continuous with each other) to cause delamination of the silver layer 24. For example, the intermediate layer 22 may be porous and such localized discontinuous lands of oxide may form at pores of the intermediate layer 22. In some embodiments, each of the pores of the intermediate layer 22 must be no greater than approximately 0.5 micrometers to prevent the formation of localized discontinuous lands of oxide that are sufficient to cause delamination of the silver layer 24. Moreover, in some embodiments, the porosity of the intermediate layer 22 must be such that the intermediate layer 22 covers at least approximately 50% of the exterior nickel surface 28 to prevent the formation of localized discontinuous lands of oxide that are sufficient to cause delamination of the silver layer 24.

The intermediate layer 22 is configured to prevent the silver layer 24 from delaminating from the nickel layer 20 at temperatures greater than 150° C. Specifically, the intermediate layer 22 prevents oxides from forming at the interface between the layer 22 and the layer 20 and the intermediate layer 22 bonds with the layers 20 and 24 such that the bonds between the intermediate layer 22 and the layers 20 and 24 may remain sufficiently strong at temperatures greater than 150° C. to prevent the silver layer 24 from delaminating from the nickel layer 20.

Moreover, because the intermediate layer 22 prevents oxides from forming, it is not necessary to use a layer that forms intermetallics at the interface between the nickel layer 20 and the intermediate layer 22 nor at the interface between the intermediate layer 22 and the silver layer 24. For example, it is known to include an intermetallic forming layer to thereby form intermetallics at the interfaces between the nickel and silver layers to provide sufficiently strong adhesion between the nickel and silver layers and thereby mitigate weakening of the adhesion caused by the formation of oxide layers. But, forming intermetallics may be difficult and/or costly. For example, it may be necessary to heat treat the electrical contact to sufficiently form the intermetallics between the strike layer and the nickel and silver layers. Such heat treatment adds a manufacturing step that may be relatively time consuming and/or costly. Accordingly, the PGM(s) of the intermediate layer 22 may reduce the cost, difficulty, and/or time of manufacturing the electrical contact, for example as compared to at least some known electrical contacts that include nickel and silver layers.

Moreover, because the intermediate layer 22 prevents oxidation, the intermediate layer 22 may be thinner than the strike layer of at least some known electrical contacts that include nickel and silver layers. For example, at least some known strike layers may not prevent oxidation therefore may be required to have a sufficient thickness that provides enough intermetallic formation with sufficiently strong adhesion to sufficiently mitigate weakening of the adhesion between the nickel and silver layers caused by the formation of any oxide layers. By preventing oxide layers from forming at the interfaces between the layer 22 and the layers 20 and 24, the intermediate layer 22 prevents the bonds between the layer 22 and the layers 20 and 24 from being weakened by such oxide layers. The thickness T₁ of the intermediate layer 22 may therefore be reduced as compared to the strike layer of at least some known electrical contacts that include nickel and silver layers. The thickness T₁ of the intermediate layer 22 may selected to provide the bonds between the layer 22 and the layers 20 and 24 with a sufficient strength to prevent the silver layer 24 from delaminating from the nickel layer 20 at a predetermined temperature that is greater than 150° C.

FIG. 4 is a flowchart illustrating a method 200 for fabricating an electrical contact, for example the electrical contact 10 (FIGS. 1 and 2) or the electrical contact 110 (FIG. 3). At 402, the method 400 includes depositing an intermediate layer (e.g., the intermediate layer 22 shown in FIG. 2 or the intermediate layer 122 shown in FIG. 3) on an exterior surface (e.g., the exterior nickel surface 28 shown in FIG. 2 or the exterior surface 128 shown in FIG. 3) of an interior layer (e.g., the nickel layer 20 shown in FIG. 2 or the nickel layer 120 shown in FIG. 3) of the electrical contact. Depositing at 402 the intermediate layer on the exterior surface of the interior layer may include bonding, at 402a, a crystalline structure of the intermediate layer with a crystalline structure of the interior layer.

The intermediate layer may be deposited at 402 on the exterior surface of the interior layer using any process, such as, but not limited to, a plating process, a spraying process, a sputtering process, a chemical vapor deposition (CVD) process, and/or the like. Any type of plating process may be used to deposit the intermediate layer on the exterior surface of the interior layer, such as, but not limited to, electroplating, electroless plating, and/or the like. Accordingly, depositing at 402 the intermediate layer on the exterior surface of the interior layer optionally includes depositing at 402b the intermediate layer on the exterior surface of the interior layer using a plating process.

At 404, the method 400 includes depositing a silver layer (e.g., the silver layer 24 shown in FIG. 2 or the silver layer 124 shown in FIG. 3) on an exterior PGM surface (e.g., the exterior PGM surface 30 shown in FIG. 2 or the exterior PGM surface 130 shown in FIG. 3) of the intermediate layer such that the intermediate layer extends between the interior layer and the silver layer. Depositing at 404 the silver layer on the exterior PGM surface of the intermediate layer may include bonding, at 404a, a crystalline structure of the silver layer with the crystalline structure of the intermediate layer.

The silver layer may be deposited at 404 on the exterior PGM surface of the intermediate layer using any process, such as, but not limited to, a plating process, a spraying process, a sputtering process, a chemical vapor deposition (CVD) process, and/or the like. Any type of plating process may be used to deposit the silver layer on the exterior PGM surface of the intermediate layer, such as, but not limited to, electroplating, electroless plating, and/or the like. Accordingly, depositing at 404 the silver layer on the exterior PGM surface of the intermediate layer optionally includes depositing at 404b the silver layer on the exterior PGM surface of the intermediate layer using a plating process.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. An electrical component comprising:
an interior layer having an exterior surface;
an intermediate layer comprising at least one platinum group metal (PGM), the intermediate layer extending on the exterior surface of the interior layer, the intermediate layer having an exterior PGM surface; and
a silver layer comprising silver, the silver layer extending on the exterior PGM surface such that the intermediate layer extends between the interior layer and the silver layer.

2. The electrical component of claim 1, wherein the interior layer is a nickel layer that is fabricated at least partially from nickel and the exterior surface is an exterior nickel surface.

3. The electrical component of claim 2, wherein the intermediate layer and the nickel layer are bonded with each other, the intermediate layer and the silver layer being bonded with each other.

4. The electrical component of claim 2, wherein the at least one PGM comprises at least one of ruthenium, rhodium, palladium, osmium, iridium, or platinum.

5. The electrical component of claim 2, wherein the intermediate layer prevents an oxide layer from forming on the exterior nickel surface.

6. The electrical component of claim 2, wherein the intermediate layer does not oxidize.

7. The electrical component of claim 2, wherein the silver layer does not delaminate when the electrical contact is exposed to a temperature equal to or greater than approximately 150° C.

8. The electrical component of claim 2, wherein the intermediate layer has a thickness between the nickel layer and the silver layer of between approximately 2 nanometers and approximately 501 nanometers.

9. The electrical component of claim 2, wherein the at least one PGM of the intermediate layer is a single PGM, an approximate entirety of the intermediate layer being fabricated from the single PGM.

10. The electrical component of claim 2, wherein at least one of:
an approximate entirety of the nickel layer is fabricated from nickel;
an approximate entirety of the intermediate layer is fabricated from the at least one PGM; or
an approximate entirety of the silver layer is fabricated from silver.

11. The electrical component of claim 2, further comprising a base having an exterior base surface, the nickel layer extending on the exterior base surface of the base.

12. A method for fabricating an electrical component, the method comprising:
depositing an intermediate layer on an exterior surface of an interior layer of the electrical component, wherein the intermediate layer comprises at least one platinum group metal (PGM) and has an exterior PGM surface; and
depositing a silver layer on the exterior PGM surface of the intermediate layer such that the intermediate layer extends between the interior layer and the silver layer, wherein the silver layer is fabricated at least partially from silver.

13. The method of claim 12, wherein the interior layer is a nickel layer that is fabricated at least partially from nickel and the exterior surface is an exterior nickel surface.

14. The method of claim 12, wherein depositing the intermediate layer on the exterior surface of the interior layer comprises bonding a crystalline structure of the intermediate layer with a crystalline structure of the interior layer, and wherein depositing the silver layer on the exterior PGM surface of the intermediate layer comprises bonding a crystalline structure of the silver layer with a crystalline structure of the intermediate layer.

15. The method of claim 12, wherein the at least one PGM includes at least one of ruthenium, rhodium, palladium, osmium, iridium, or platinum.

16. The method of claim 12, wherein depositing the intermediate layer on the exterior surface of the interior layer comprises depositing the intermediate layer such that the intermediate layer has a thickness between the interior layer and the silver layer of less than approximately 500 nanometers.

17. The method of claim 12, wherein depositing the intermediate layer on the exterior surface of the interior layer comprises depositing the intermediate layer on the exterior surface using a plating process.

18. The method of claim 12, wherein depositing the silver layer on the exterior PGM surface of the intermediate layer comprises depositing the silver layer on the PGM surface using a plating process.

19. An electrical component comprising:
an interior layer having an exterior surface;
an intermediate layer extending on the exterior surface of the interior layer, the intermediate layer having an exterior PGM surface; and
a silver layer comprising silver, the silver layer extending on the exterior PGM surface such that the intermediate layer extends between the interior layer and the silver layer, wherein the intermediate layer is fabricated from at least one material that does not oxidize such that the intermediate layer provides a barrier that prevents an oxide layer from forming on the exterior surface of the interior layer.

20. The electrical component of claim 19, wherein the intermediate layer includes at least one platinum group metal (PGM).
